(19) United States
(12) Patent Application Publication
(10) Pub. No.: US 2012/0132232 A1
(43) Pub. Date: May 31, 2012

(54) PIPING CLEANING NOZZLE AND PIPING CLEANIGN METHOD USING PIPING CLEANING NOZZLE

(75) Inventors: Taketo Kawabata, Tatatsuki-shi (JP); Masaharu Kosaka, Tatatsuki-shi (JP); Junichiro Katayama, Tatatsuki-shi (JP)

(73) Assignee: SEMCO CO., LTD., TOKATSUKI-OSAKA (JP)

(21) Appl. No.: 13/389,314

(22) PCT Filed: Aug. 7, 2009
(86) PCT No.: PCT/JP2009/063999

§ 371 Date: Feb. 7, 2012

(51) Int. Cl. B08B 9/027; B08B 9/02

(52) U.S. Cl. 134/22.11; 134/166 C

(57) ABSTRACT

Provided are a piping cleaning nozzle which effectively prevents back flow of a cleaning agent poured into piping in a building to clean the inner wall of the piping and to exterminate noxious organisms, and a piping cleaning method using the piping cleaning nozzle. An expanding and contracting body (4) is mounted to the front end side of a pipe (3) constituting a nozzle inserted into piping. The expanding and contracting body (4) is adapted to cover nozzle holes (8) for discharging a cleaning agent and consists of a material such a rubber expanded by the cleaning agent discharged to the inside of the expanding and contracting body (4). In cleaning operation, the pressure of the cleaning agent discharged from the nozzle holes (8) expands the expanding and contracting body (4) to close the piping. As a result, the expanding and contracting body (4) functions as a lid for blocking the cleaning agent which comes out of a discharge opening (6) and tried to flow back. This causes the cleaning agent to be effectively prevented from flowing back and to be sent to a portion deep inside the piping, enhancing cleaning efficiency.

### TECHNICAL FIELD

The present invention relates to a piping cleaning nozzle for injecting a cleaning agent into piping which is to be used for cleaning an internal wall of piping in a building, and a piping cleaning method using the piping cleaning nozzle.

### BACKGROUND ART

In a work for cleaning an internal wall of piping in a building, there is widely carried out an operation for inserting a nozzle for feeding a cleaning agent into the piping and injecting a liquid or foamed cleaning agent into an inner part of the piping through the nozzle. In the method for cleaning the internal wall of the piping, it is an object to feed the cleaning agent to a deep part of the piping in order to enable cleaning for piping provided in a deep part of a building.

Therefore, there is disclosed the invention for enhancing a rectilinear stability of a nozzle with a structure in which a tip part of the nozzle for jetting a cleaning agent is rotated in order to easily cause the nozzle to enter an inner part of piping along an internal wall of the piping (see Patent Document 1). Moreover, there is disclosed the invention for feeding a cleaning agent to a deep part in piping by using a high pressure hose and sliding a nozzle spirally, thereby enhancing an efficiency of cleaning (see Patent Document 2).
Patent Document 1: Japanese Laid-Open Patent Publication No. 2006-305449
Patent Document 2: Japanese Laid-Open Patent Publication No. 2006-21175

### DISCLOSURE OF THE INVENTION

### Problems to be Solved

When the cleaning agent is jetted into the piping by the method described above, a pressure in the piping is raised by the cleaning agent jetted suddenly. In addition to the purpose of cleaning, a foamed insecticide is used as the cleaning agent to exterminate noxious organisms in a deep part of the piping which an ordinary insecticide does not reach. However, a bubble generated by the foamed cleaning agent tends to flow backward. For this reason, it is an object to prevent the bubble flowing backward from being blown out of an inlet of the piping.

With regard to the object, in the inventions disclosed in the Patent Documents 1 and 2, diameters of tip parts of rotating nozzles are not always coincident with each other for piping having various inside diameters. For this reason, a clearance is generated between an internal wall of the piping and the tip part so that the backward flow of the cleaning agent cannot be prevented.

In order to solve the problem, it is an object of the present invention to provide a piping cleaning nozzle for injecting a cleaning agent into piping and a piping cleaning method using the piping cleaning nozzle which are effective for preventing a backward flow of the cleaning agent to be injected into the piping in order to clean an internal wall of the piping in a building or to exterminate noxious organisms.

### Means for Solving the Problem

The invention relating to a piping cleaning nozzle for solving the problem provides a piping cleaning nozzle for injecting a cleaning agent into piping, wherein a tube portion through which a cleaning agent flows at a tip side of the nozzle to be inserted into the piping is provided with at least one jet hole for jetting the cleaning agent, and an expanding and contracting body for covering the jet hole and expanding by a pressure of the cleaning agent jetted from the jet hole is provided.

The present invention can also be characterized in that the jet hole is provided in a side surface part of the tube portion, and the expanding and contracting body is provided with a discharge port for discharging the cleaning agent jetted into the expanding and contracting body.

The present invention can also be characterized in that the jet hole is provided in a tip part of the tube portion, and the expanding and contracting body is provided with a discharge port for discharging the cleaning agent jetted into the expanding and contracting body.

The present invention can also be characterized in that the jet hole is provided in a side surface part of the tube portion, and a tip part of the tube portion is provided with a discharge port for discharging the cleaning agent to the piping.

In the present invention, there is employed the structure in which the expanding and contracting body which is formed by a material such as a rubber and expands by the cleaning agent is provided on the tip side of the tube portion of the nozzle to be inserted into the piping, and the expanding and contracting body expands by the pressure of the cleaning agent to be jetted in the cleaning so that an inner part of the piping is blocked. Therefore, the expanding and contracting body serves as a cover for the cleaning agent which tries to flow backward, thereby preventing the backward flow of the cleaning agent effectively. Consequently, it is possible to feed the cleaning agent into a deep part of the piping.

Although the structure in which the cleaning agent is fed into the piping is not particularly restricted in the present invention, it is also possible to employ a structure in which the cleaning agent jetted into the expanding and contracting body is discharged into the piping from the discharge port provided on the expanding and contracting body or a structure in which the expanding and contracting body is provided on upstream side from the tip of the tube portion in the nozzle and the cleaning agent is discharged into the piping from the discharge port provided on the tip part of the tube portion of the nozzle separately from the jet hole of the expanding and contracting body portion.

It is sufficient that a liquid or foamed cleaning agent is used for the cleaning agent to be used in the present invention. However, any type of the cleaning agent capable of causing the expanding and contracting body to expand is not particularly restricted. In addition to the cleaning agent intended for only the cleaning, a cleaning agent containing a drug for exterminating noxious organisms is also included in the cleaning agent to be used in the present invention. A material of the expanding and contracting body which can expand and contract is not particularly restricted. For example, a rubber material such as a natural rubber or a chloroprene rubber is used.

Moreover, the present invention may be characterized in that at least one pair of removable sticking members for folding the expanding and contracting body to carry out sticking in a state brought before an expansion are provided on a surface of the expanding and contracting body.

With the structure, if the expanding and contracting body is fixed in a folding state, the nozzle can easily be inserted into the piping, and furthermore, the expanding and contracting body expands so that the sticking members such as hook-and-loop fasteners are naturally removed from each other to block the inner part of the piping when the cleaning is started. Consequently, the structure is effective for enhancing a construction efficiency.

The present invention can also be specified as a piping cleaning method using the piping cleaning nozzle according to the present invention.

In other words, the invention relating to the piping cleaning method using the piping cleaning nozzle provides a piping cleaning method for injecting a cleaning agent by using a piping cleaning nozzle in piping, the piping cleaning nozzle is provided with at least one jet hole for jetting a cleaning agent in a tube portion through which the cleaning agent flows at a tip side of the nozzle to be inserted into the piping, and an expanding and contracting body for covering the jet hole and expanding by a pressure of the cleaning agent jetted from the jet hole is provided, and the cleaning agent is injected into the tube portion in a state in which the piping cleaning nozzle is inserted into the piping, and the cleaning agent is injected into the piping in a state in which the piping is sealed with the expanding and contracting body that expands by a pressure of the cleaning agent jetted from the jet hole.

The present invention relating to the piping cleaning method can also be characterized in that the jet hole is provided in a side surface part of the tube portion, and the expanding and contracting body is provided with a discharge port for discharging the cleaning agent jetted into the expanding and contracting body in the piping cleaning nozzle, and the cleaning agent discharged from the discharge port is injected into the piping to clean the piping.

The present invention relating to the piping cleaning method can also be characterized in that the jet hole is provided in a tip part of the tube portion, and the expanding and contracting body is provided with a discharge port for discharging the cleaning agent jetted into the expanding and contracting body in the piping cleaning nozzle, and the cleaning agent discharged from the discharge port is injected into the piping to clean the piping.

The present invention relating to the piping cleaning method can also be characterized in that the jet hole is provided in a side surface part of the tube portion, and a tip part of the tube portion is provided with a discharge port for discharging the cleaning agent to the piping in the piping cleaning nozzle, and the cleaning agent discharged from the discharge port is injected into the piping to clean the piping.

Moreover, the present invention relating to the piping cleaning method may be characterized in that at least one pair of removable sticking members for folding the expanding and contracting body to carryout sticking in a state brought before an expansion are provided on a surface of the expanding and contracting body in the piping cleaning nozzle, the piping cleaning nozzle is inserted into the piping in a state in which the sticking members stick together, and the sticking members are separated from each other to seal the piping when the expanding and contracting body expands by the pressure of the cleaning agent.

### Effect of the Invention

According to the present invention, when a nozzle is to be inserted into piping of a building to inject a liquid or foamed cleaning agent from the nozzle, thereby cleaning an internal wall of the piping in the building, an expanding and contracting body which expands serves as a cover for the cleaning agent trying to flow backward, thereby preventing the backward flow of the cleaning agent injected into the piping effectively, and feeds the cleaning agent into a deep part of the piping, thereby enhancing a cleaning capability.

### BRIEF DESCRIPTION OF THE DRAWINGS

FIG. 1 is a view showing a structure of a whole cleaning unit using a piping cleaning nozzle according to the present invention.

FIG. 2 is a view showing a state in which the piping cleaning nozzle according to the present invention is inserted into piping disposed horizontally.

FIG. 3 is a view showing a state in which the piping cleaning nozzle according to the present invention is inserted into the piping disposed vertically.

FIG. 4 is a view showing a structure of an expanding and contracting body portion according to a first embodiment of the piping cleaning nozzle in accordance with the present invention.

FIG. 5 is a view showing a structure of an expanding and contracting body portion according to a second embodiment of the piping cleaning nozzle in accordance with the present invention.

FIG. 6 is a view showing a structure of an expanding and contracting body portion according to a third embodiment of the piping cleaning nozzle in accordance with the present invention.

FIG. 7 is a view showing a state brought before an expansion in piping of an expanding and contracting body of the piping cleaning nozzle according to the present invention.

FIG. 8 is a view showing a state brought after the expansion in the piping of the expanding and contracting body of the piping cleaning nozzle according to the present invention.

FIG. 9 is a view showing a state in which the expanding and contracting body portions of the piping cleaning nozzle according to the present invention are caused to stick through a hook-and-loop fastener.

### EXPLANATION OF DESIGNATION

1 cleaning agent supplying machine
2 hose
3 pipe
4 expanding and contracting body
5 band
6 discharge port
7 stopper
8 jet hole
9 hook-and-loop fastener
10 piping
11 drainage measure

### BEST MODE FOR CARRYING OUT THE INVENTION

An embodiment for carrying out the present invention will be described below in detail with reference to the drawings. In the following explanation, the embodiment according to the present invention is only illustrative and a structure of each portion in a piping cleaning nozzle or the like according to the present invention is not restricted to a configuration which will be described below. Moreover, an application of the present invention is not restricted to a business use such as cleaning of a building or a factory or an extermination of noxious organisms, or may be an employment for a household aerosol or the like.

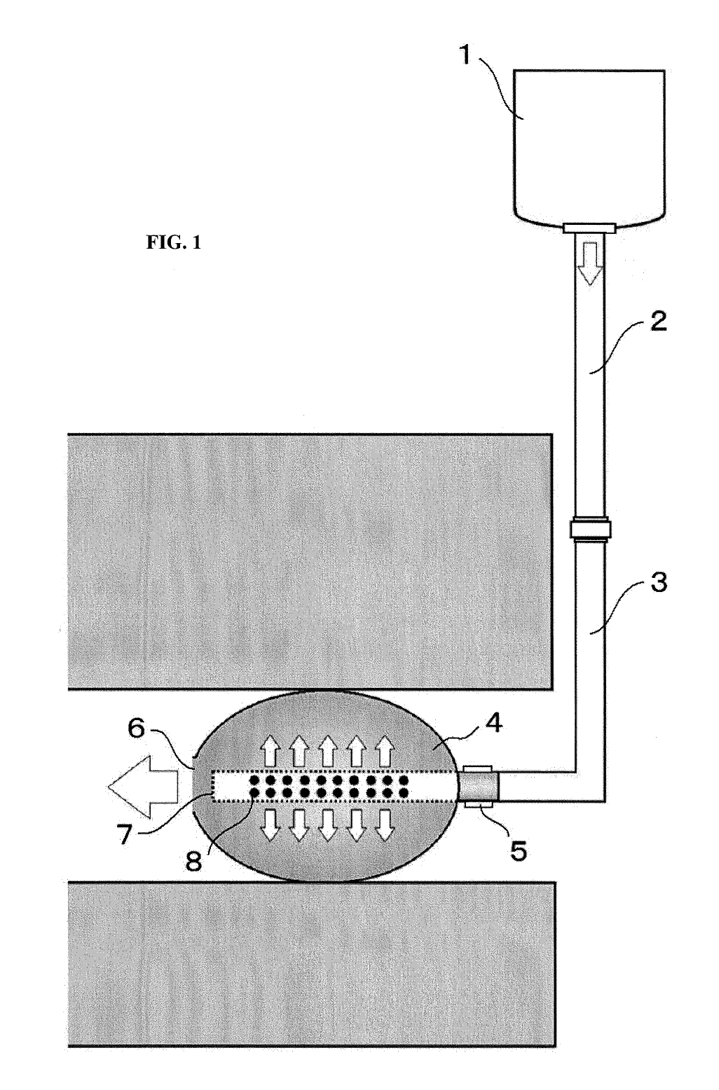

FIG. 1 shows an example of a structure of a whole cleaning unit using the piping cleaning nozzle according to the present invention. The cleaning unit using the piping cleaning nozzle according to the present invention is constituted by a cleaning agent supplying machine 1, a hose 2, a pipe 3, and an expanding and contracting body 4. The expanding and contracting body 4 is fixed to the pipe 3 by means of a band 5, and has a discharge port 6 provided in a tip part. A tip of the pipe 3 serves as a stopper 7 and a side surface covered with the expanding and contracting body 4 is provided with a jet hole 8.

A liquid or foamed cleaning agent is fed from the cleaning agent supplying machine 1 to the hose 2. The pipe 3 having the tip side covered with the expanding and contracting body 4 serves as a piping cleaning nozzle and is connected to the hose 2 by means of a fastener. However, the pipe 3 and the hose 2 can be removed from each other, and the piping cleaning nozzle can be attached to various cleaning agent supplying machines 1 through the hose 2.

A type of the cleaning agent supplying machine 1 to be used in the present invention is not particularly restricted but needs to have a function for feeding a cleaning agent flowing in the hose 2 and the pipe 2 into piping. A type of the cleaning agent to be fed out is not particularly restricted but a cleaning agent such as a gas or powder may be used. In order to cause the cleaning agent jetted from the jet hole 8 to generate a pressure in the expanding and contracting body 4, however, a cleaning agent such as a liquid or a bubble is suitable. In the case in which a foamed cleaning agent is fed out, a bubble generating mechanism is provided in the cleaning agent supplying machine. As described above, the cleaning agent to be used herein is not always intended for only cleaning but a cleaning agent containing a drug for exterminating noxious organisms may be employed.

In the case in which the cleaning unit is a business use such as cleaning of a building or a factory, a cleaning agent supplying machine having a comparatively large-sized pump function is used. In the case in which the cleaning unit is used for exterminating noxious organisms in home or the like, an aerosol filled with a liquid or powder drug and a liquefied gas can also be used for the liquefied gas.

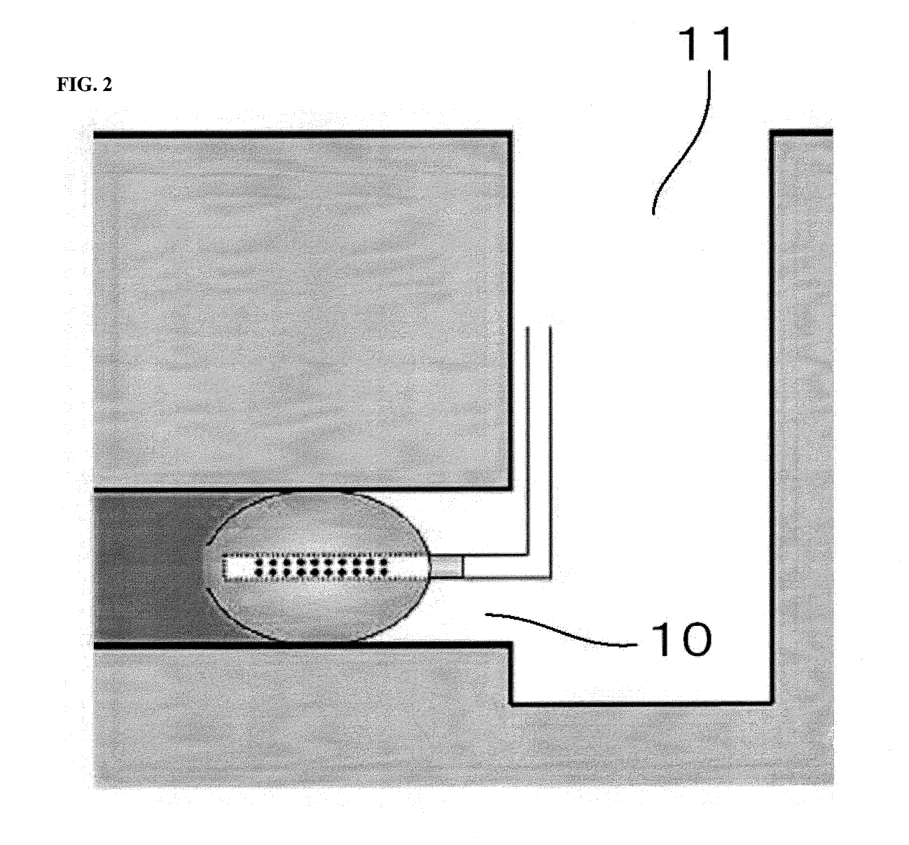

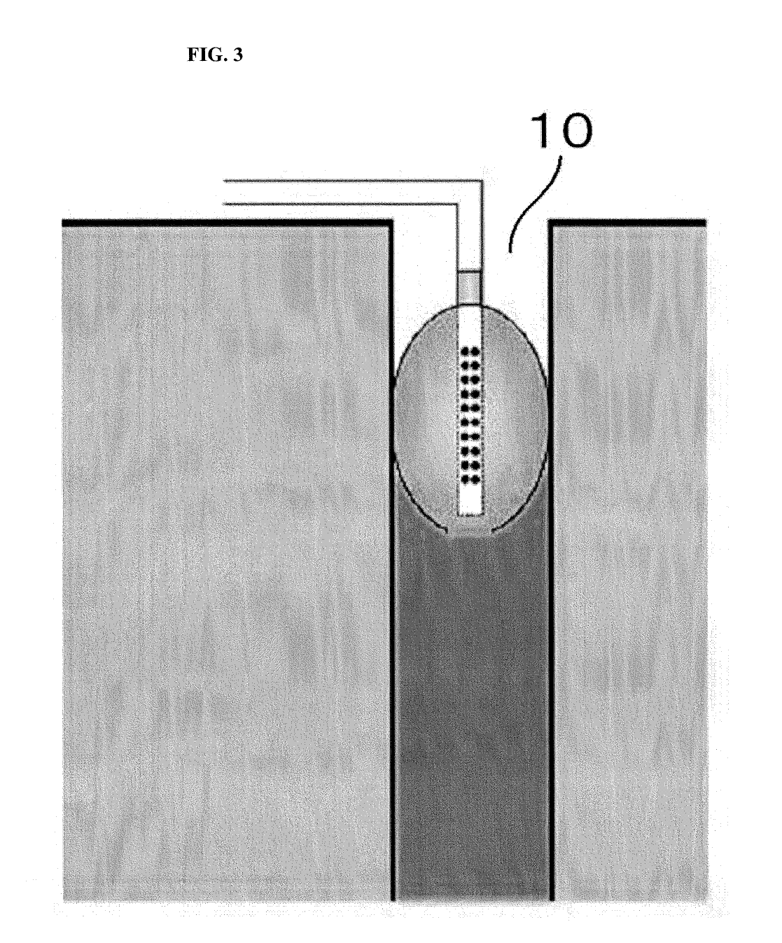

Both the hose 2 and the pipe 3 are tubes serving as passages for the cleaning agent fed from the cleaning agent supplying machine 1. While a soft material is used for the hose 2, a hard material having a fixed shape, for example, a metal, a plastic or the like is used for the pipe 3. If a material bent at a right angle or a close angle thereto is used for the pipe 3, there is obtained a structure in which a nozzle can easily be inserted in a construction of piping disposed horizontally or vertically with respect to a floor surface as shown in examples of FIGS. 2 and 3. In the case in which piping 10 is disposed horizontally with respect to a drainage measure 11 in piping in a place in which the drainage measure 11 is provided as shown in FIG. 2, particularly, it is hard to push the nozzle into the piping 10 by hand because of a depth of the drainage measure 11. For this reason, the bent pipe 3 is suitable.

However, it is sufficient that the pipe 3 serves as a passage for injecting the cleaning agent into the piping. Therefore, any tubular member through which a fluid can pass is employed. A soft material which is changeable in shape like that of the hose 2 may be used in pipe 3. In that case, it is also possible to use a material forming a tube portion having the hose 2 and the pipe 3 integrated with each other.

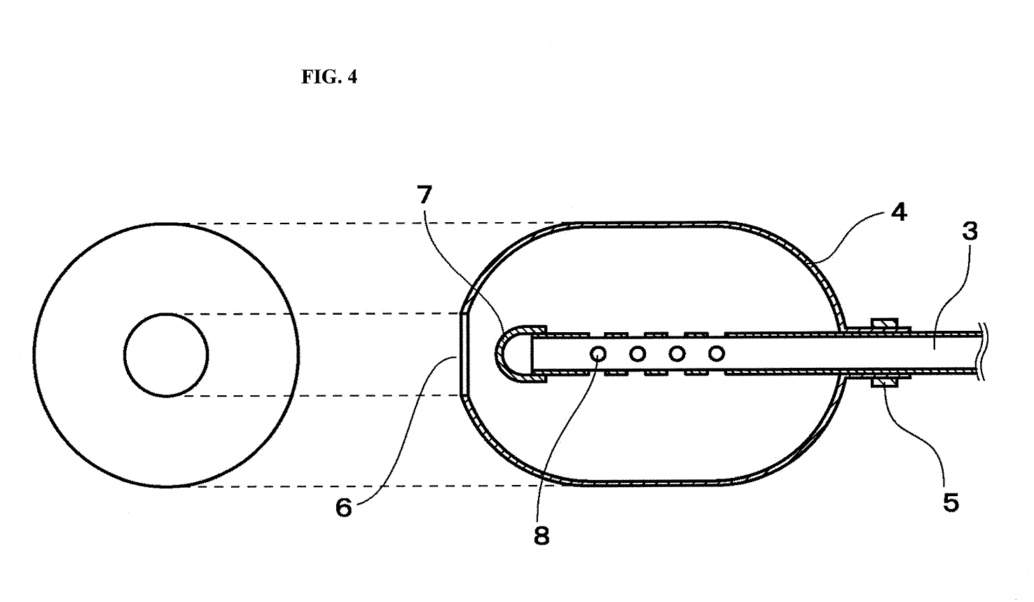

The pipe 3 has the jet hole 8 provided on a side surface covered with the expanding and contracting body 4, and the cleaning agent fed out of the cleaning agent supplying machine 1 is jetted therefrom into the expanding and contracting body 4 to cause the expanding and contracting body 4 to expand. Although the tip of the pipe 3 serves as the stopper 7, various embodiments are applied to a structure for jetting the cleaning agent as will be described below with reference to FIGS. 4 to 6.

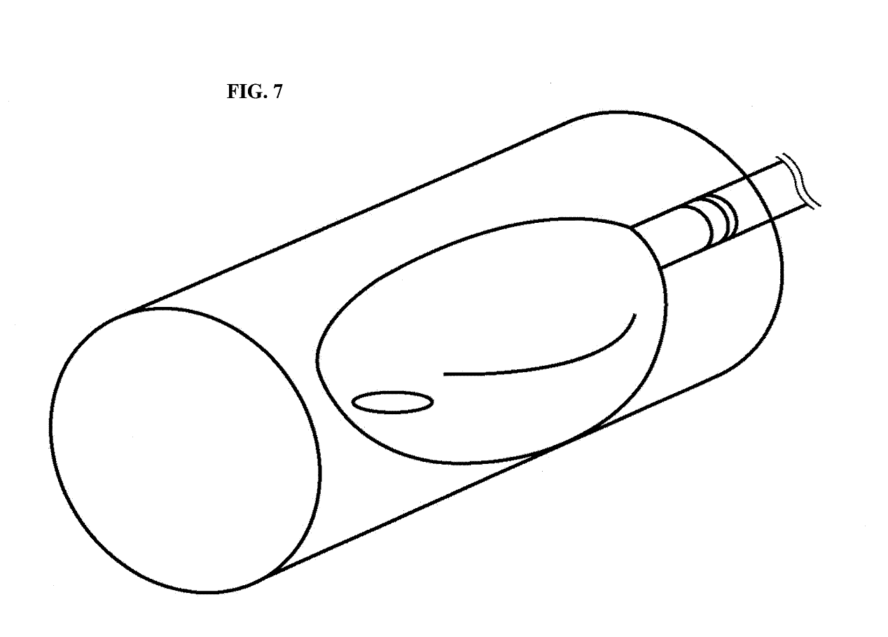

A material such as a rubber, for example, a natural rubber, a chloroprene rubber or the like which expands or contracts by a pressure of the cleaning agent jetted from the jet hole 8 is used for the expanding and contracting body 4. Before the cleaning agent is fed out of the cleaning agent supplying machine 1, a clearance is generated between the expanding and contracting body 4 and the piping in a state in which the expanding and contracting body 4 contracts in the piping as shown in FIG. 7. Therefore, the nozzle can easily be inserted into the piping.

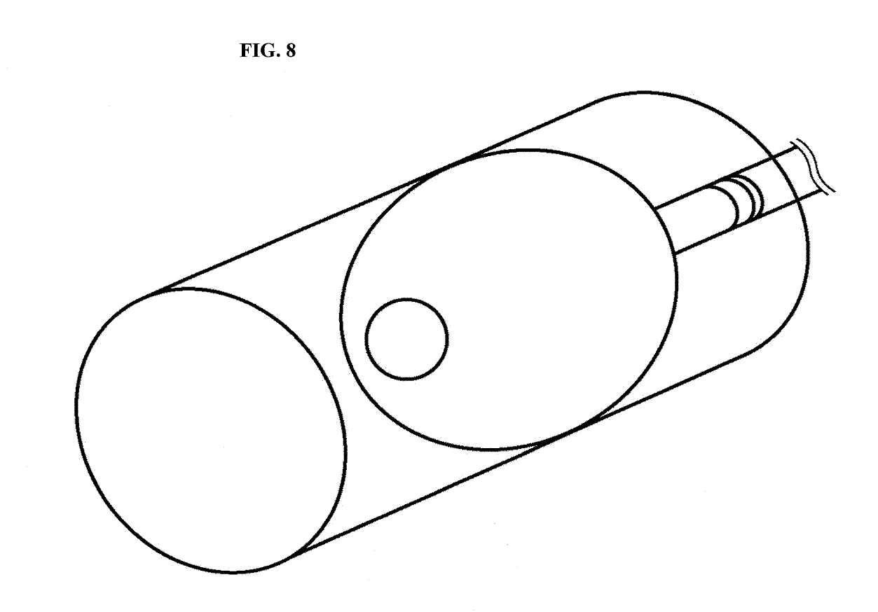

When the cleaning agent is fed out of the cleaning agent supplying machine 1 and is jetted from the jet hole 8 so that a pressure in the expanding and contracting body 4 is raised, however, the expanding and contracting body 4 is brought into an expanding state in the piping so that the piping is sealed with the expanding and contracting body 4 as shown in FIG. 8. The cleaning agent stored in the expanding and contracting body 4 is discharged from the discharge port 6 into the piping. Therefore, the cleaning agent is injected into the piping in a state in which the inner part of the piping is blocked with the expanding and contracting body 4. Thus, a deep part of the piping can also be cleaned.

When the operation for feeding the cleaning agent out of the cleaning agent supplying machine 1 is stopped, furthermore, the operation for jetting the cleaning agent from the jet hole 8 is also stopped so that the pressure in the expanding and contracting body 4 is reduced to bring the state shown in FIG. 7 again. When this state is brought again, the nozzle can easily be pulled out of the piping.

Although the expanding and contracting body 4 is fixed to the pipe 3 by means of the band 5 such as a hose band, a method for fixing the expanding and contracting body 4 to the pipe 3 is not particularly restricted but both of them may be formed integrally. In consideration of the fact that only the expanding and contracting body 4 can be exchanged when the expanding and contracting body 4 is broken, however, it is suitable to employ a structure in which the removable expanding and contracting body 4 is fixed by the band 5.

A shape of the expanding and contracting body 4 is not particularly restricted. In order to enhance an effect for sealing the piping, however, it is preferable to have a certain degree of length (a depth for the piping) in order to increase an area formed in contact with the piping. In order to have a structure in which the expanding and contracting body 4 in the expanding state is pulled out of the piping with more difficulty, moreover, it is also possible to provide a concavo-convex portion like a spike of a tire on a surface of the expanding and contracting body 4 disposed in contact with the piping.

FIGS. 4 to 6 show three embodiments of a structure for jetting the cleaning agent from the nozzle. Although the structure for jetting the cleaning agent is not restricted to the examples shown herein, these examples are typical embodiments according to the present invention.

FIG. 4 shows the same embodiment as the structure described with reference to FIG. 1, and the jet hole 8 is provided in the side surface part of the pipe 3 and the cleaning agent is jetted from the vicinity of a central part of the expanding and contracting body 4 into the expanding and contracting body 4 covering the jet hole 8. The expanding and contracting body 4 is provided with the discharge port 6 for discharging the cleaning agent to be jetted into the inner part of the expanding and contracting body, and the cleaning agent is discharged from the discharge port 6 into the piping.

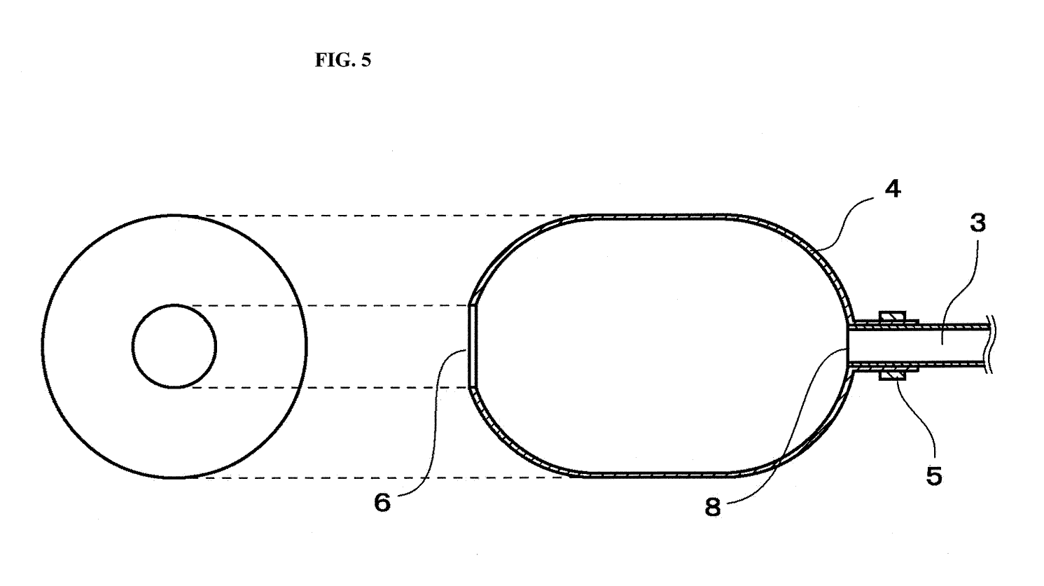

FIG. 5 also shows the embodiment in which the cleaning agent is discharged from the discharge port 6 into the piping in the same manner as FIG. 4, and the jet hole 8 is provided in the tip part of the pipe 3 and the cleaning agent is jetted from an end side of the expanding and contracting body 4 into the expanding and contracting body 4 covering the jet hole 8. In the same manner as in the embodiment shown in FIG. 4, the expanding and contracting body 4 is provided with the discharge port 6 for discharging the cleaning agent jetted into the expanding and contracting body, and the cleaning agent is discharged from the discharge port 6 into the piping.

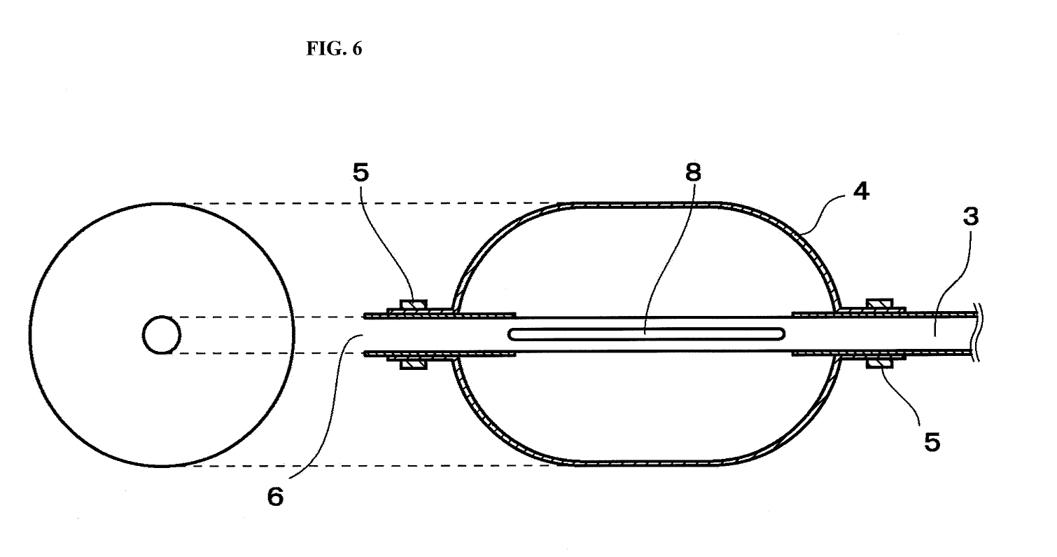

FIG. 6 shows the embodiment in which the cleaning agent is discharged from the discharge port 6 provided in the tip part of the pipe 3, and the jet hole 8 is provided in the vicinity of a central part of a portion of the pipe 3 which is covered with the expanding and contracting body 4 and the cleaning agent is jetted from the vicinity of the central part of the expanding and contracting body 4 into the expanding and contracting body 4 covering the jet hole 8. In the embodiment, both ends of the expanding and contracting body 4 are fixed to the pipe 3 by means of the band 5. Therefore, the cleaning agent is not discharged from the expanding and contracting body 4 but is discharged into the piping from the discharge port 6 provided in the tip part of the pipe 3 separately from the jet hole 8.

Although the jet hole 8 is a round hole in FIG. 4 and is an oblong hole in FIG. 6, the shapes of the jet hole 8 are not particularly restricted thereto but they may be reverse to each other. Moreover, the number of the jet holes 8 is not restricted and at least one jet hole 8 is provided.

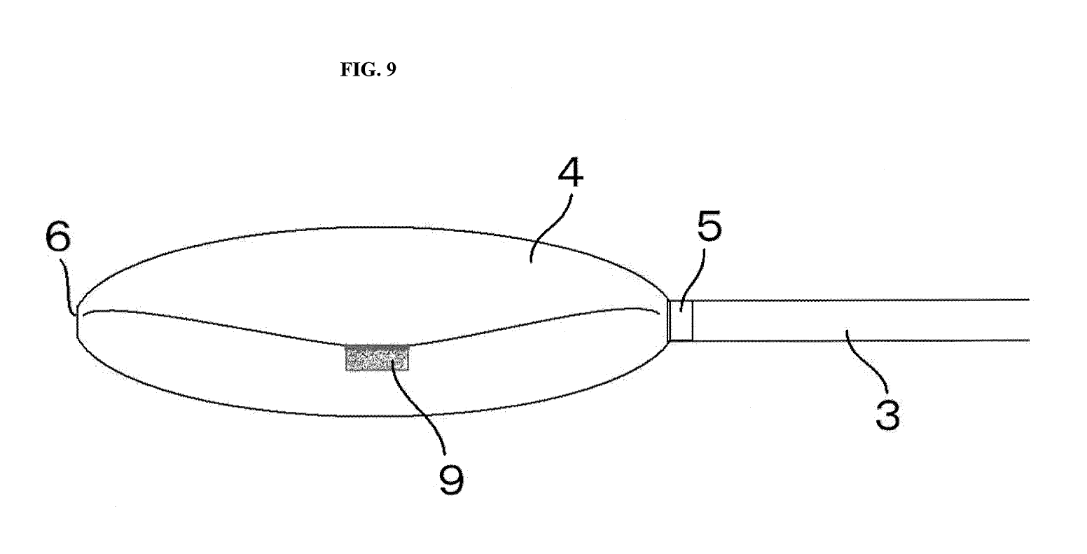

In the example shown in FIG. 9, sticking members such as a pair of hook-and-loop fasteners 9 are provided on a surface of the expanding and contracting body 4, and the expanding and contracting body 4 can be folded to be compact by causing the hook-and-loop fasteners 9 to stick together in a state in which the expanding and contracting body 4 contracts. With the structure, the expanding and contracting body 4 is folded to be compact. Therefore, the nozzle can easily be inserted into the piping, and furthermore, the sticking of the hook-and-loop fasteners 9 is naturally removed when the cleaning agent is started to be fed out so that the expanding and contracting body 4 expands.

The sticking member to be used herein is not restricted to the hook-and-loop fastener but a hook or the like may be used as the sticking member. Moreover, a pair of sticking members are not restricted but at least two pairs of sticking members may be provided on the single expanding and contracting body 4.

### Example 1

Description will be given to an example in which a cleaning agent is injected into piping by using a piping cleaning unit according to the present invention.

Rubber materials, that is, a natural rubber and a chloroprene rubber were used for the expanding and contracting body 4. A maximum diameter of a section taken perpendicularly to the pipe 3 was set to be 17 cm, and a diameter of the discharge port 6 was set to be 3 cm.

A mousse-like foamed cleaning agent was used for the cleaning agent, and the cleaning agent was fed out in a supply amount of 5.5 litters/minute from the cleaning agent supplying machine 1 with a supply pressure of a compressor set to be 0.4 Mpa. Since the cleaning agent is foamed, an actual volume of the cleaning agent is increased to be several ten times as large as its own volume.

On the condition described above, the cleaning agent was injected into piping having a diameter of 75 mm so that it was moved to a deep part in the piping at a speed of 25 cm/second. On the same condition, the cleaning agent was injected into piping having a diameter of 150 mm so that it was moved to the deep part in the piping at a speed of 8 cm/second. As described above, it was confirmed that the piping can be cleaned efficiently by means of the piping cleaning unit according to the present invention.

1. A piping cleaning nozzle for injecting a cleaning agent into piping,
wherein a tube portion through which a cleaning agent flows at a tip side of the nozzle to be inserted into the piping is provided with at least one jet hole for jetting the cleaning agent, and
an expanding and contracting body for covering the jet hole and expanding by a pressure of the cleaning agent jetted from the jet hole is provided.

2. The piping cleaning nozzle according to claim 1, wherein the jet hole is provided in a side surface part of the tube portion, and
the expanding and contracting body is provided with a discharge port for discharging the cleaning agent jetted into the expanding and contracting body.

3. The piping cleaning nozzle according to claim 1, wherein the jet hole is provided in a tip part of the tube portion, and
the expanding and contracting body is provided with a discharge port for discharging the cleaning agent jetted into the expanding and contracting body.

4. The piping cleaning nozzle according to claim 1, wherein the jet hole is provided in a side surface part of the tube portion, and
a tip part of the tube portion is provided with a discharge port for discharging the cleaning agent to the piping.

5. The piping cleaning nozzle according to claim 1, wherein at least one pair of removable sticking members for folding the expanding and contracting body to carry out sticking in a state brought before an expansion are provided on a surface of the expanding and contracting body.

6. A piping cleaning method for injecting a cleaning agent by using a piping cleaning nozzle in piping,
wherein the piping cleaning nozzle is provided with at least one jet hole for jetting a cleaning agent in a tube portion through which the cleaning agent flows at a tip side of the nozzle to be inserted into the piping, and an expanding and contracting body for covering the jet hole and expanding by a pressure of the cleaning agent jetted from the jet hole is provided, and
the cleaning agent is injected into the tube portion in a state in which the piping cleaning nozzle is inserted into the piping, and the cleaning agent is injected into the piping in a state in which the piping is sealed with the expanding and contracting body that expands by a pressure of the cleaning agent jetted from the jet hole.

7. The piping cleaning method according to claim 6, wherein the jet hole is provided in a side surface part of the tube portion, and the expanding and contracting body is provided with a discharge port for discharging the cleaning agent jetted into the expanding and contracting body in the piping cleaning nozzle, and
the cleaning agent discharged from the discharge port is injected into the piping to clean the piping.

8. The piping cleaning method according to claim 6, wherein the jet hole is provided in a tip part of the tube portion, and the expanding and contracting body is provided with a discharge port for discharging the cleaning agent jetted into the expanding and contracting body in the piping cleaning nozzle, and
the cleaning agent discharged from the discharge port is injected into the piping to clean the piping.

9. The piping cleaning method according to claim 6, wherein the jet hole is provided in a side surface part of the tube portion, and a tip part of the tube portion is provided with a discharge port for discharging the cleaning agent to the piping in the piping cleaning nozzle, and
the cleaning agent discharged from the discharge port is injected into the piping to clean the piping.

10. The piping cleaning method according to claim 6a, wherein at least one pair of removable bonding members for folding the expanding and contracting body to carry out sticking in a state brought before an expansion are provided on a surface of the expanding and contracting body in the piping cleaning nozzle,
the piping cleaning nozzle is inserted into the piping in a state in which the sticking members stick together, and
the sticking members are separated from each other to seal the piping when the expanding and contracting body expands by the pressure of the cleaning agent.

11. The piping cleaning nozzle according to claim 2, wherein at least one pair of removable sticking members for folding the expanding and contracting body to carry out sticking in a state brought before an expansion are provided on a surface of the expanding and contracting body.

12. The piping cleaning nozzle according to claim 3, wherein at least one pair of removable sticking members for folding the expanding and contracting body to carry out sticking in a state brought before an expansion are provided on a surface of the expanding and contracting body.

13. The piping cleaning nozzle according to claim 4, wherein at least one pair of removable sticking members for folding the expanding and contracting body to carry out sticking in a state brought before an expansion are provided on a surface of the expanding and contracting body.

14. The piping cleaning method according to claim 7, wherein at least one pair of removable bonding members for folding the expanding and contracting body to carry out sticking in a state brought before an expansion are provided on a surface of the expanding and contracting body in the piping cleaning nozzle,
the piping cleaning nozzle is inserted into the piping in a state in which the sticking members stick together, and
the sticking members are separated from each other to seal the piping when the expanding and contracting body expands by the pressure of the cleaning agent.

15. The piping cleaning method according to claim 8, wherein at least one pair of removable bonding members for folding the expanding and contracting body to carry out sticking in a state brought before an expansion are provided on a surface of the expanding and contracting body in the piping cleaning nozzle,
the piping cleaning nozzle is inserted into the piping in a state in which the sticking members stick together, and
the sticking members are separated from each other to seal the piping when the expanding and contracting body expands by the pressure of the cleaning agent.

16. The piping cleaning method according to claim 9, wherein at least one pair of removable bonding members for folding the expanding and contracting body to carry out sticking in a state brought before an expansion are provided on a surface of the expanding and contracting body in the piping cleaning nozzle,
the piping cleaning nozzle is inserted into the piping in a state in which the sticking members stick together, and
the sticking members are separated from each other to seal the piping when the expanding and contracting body expands by the pressure of the cleaning agent.
